(19) United States
(12) Patent Application Publication
(10) Pub. No.: US 2008/0088626 A1
(43) Pub. Date: Apr. 17, 2008

(54) Three-Dimensional Image Data Compression System, Method, Program and Recording Medium

(75) Inventors: Hitoshi Habe, Ikoma-shi (JP); Takashi Matsuyama, Kyoto-shi (JP); Yosuke Katsura, Setagaya-ku (JP)

Correspondence Address: CASELLA & HESPOS, 274 MADISON AVENUE, NEW YORK, NY, 10016, US

(73) Assignee: KYOTO UNIVERSITY, Kyoto (JP)

(21) Appl. No.: 11/792,731

(22) PCT Filed: Dec. 9, 2005
(86) PCT No.: PCT/JP05/22686

§ 371 Date: Jun. 8, 2007

(30) Foreign Application Priority Data
Dec. 10, 2004 (JP) 2004-358612

(51) Int. Cl. G06T 15/10

(52) U.S. Cl. 345/427

(57) ABSTRACT

A 3D image data compression system, a method a program and a recording medium storing the program are provided for effectively compressing a data amount and obtaining a decompressed 3D image with little distortion. A recording medium also is provided for storing the compressed 3D image data. The system generates, a cut path based on a texture distribution of the surface of the 3D image so as to reduce the distortion of the 3D image reproduced from the compressed data. Geometric information and optical information of the 3D image data are correlated with points within a 2D planar figure based on the texture distribution of the surface of the 3D image so as to reduce the distortion of the 3D image reproduced from the compressed data.

### TECHNOLOGICAL FIELD

The present invention relates to three-dimensional (3D) image data compression system and method for compressing a 3D image data, also to a 3D image data compression program using this 3D image data compression method and a recording medium storing this 3D image data compression program, and further to a recording medium storing a compressed 3D image data compressed by such a 3D image data compression method.

### BACKGROUND ART

Since an object in a 3D space can be represented by a set of points on the surface of the object, it can be represented by a set of data (3D image data) comprised of 3D coordinates of the points on the surface thereof (geometric information) and the optical information of these points. As one of methods for generating such a 3D image data, there is known polygonal modeling for approximating the surface of an object by planes defined by vertices. In this polygonal modeling, planes are called polygons; the presentation of a curved surface of an object by polygons is called a polygonal approximation; a 3D image of the object generated by the polygonal approximation is called a polygon mesh; and this data is called a polygon mesh data. Various methods for generating a polygon mesh data from an object have been developed. For example, methods disclosed in non-patent literatures 1 to 5 are known.

A data amount of this polygon mesh data is smaller than the one obtained in the case of representing an object by a set of points on the object surface since polygonal approximation is applied. However, the polygon mesh data is a 3D data, it is still huge in consideration of the case of transmitting or recording the polygon mesh data. Particularly, if a 3D image data is not the data of an object by computer graphics (CG), but the data of an object actually picked up or an animation data, the data amount of the polygon mesh data is quite huge. Therefore, there is a demand for a compression technique of compressing polygon mesh data.

Such a polygon mesh data compression technique is disclosed, for example, in patent literature 1. A method disclosed in this patent literature 1 and used to generate a structured polygon mesh data by approximating the surface shape of a 3D object by a polygon mesh comprised of a plurality of polygons and generate an efficient, compressible and decompressible 2D structured data from specified information on the polygon mesh is characterized by comprising a step of generating a connectedness map by correlating the respective vertices of the polygons, which are the vertices of the polygon mesh, and the respective nodes, which are grid points on a 2D coordinate system, with each other; and a step of generating the 2D structured data from specified information on the respective polygon vertices and the respective nodes correlated with each other; wherein a specified polygon vertex can be correlated with a plurality of nodes on the 2D coordinate system in the correlating step.

Further, the inventors of the present invention proposed a skin-off scheme (non-patent literature 6) as a polygon mesh data compression technique. FIG. 14 are diagrams showing the skin-off scheme. FIG. 14A shows a polygonally approximated object to which the skin-off scheme is applied, FIG. 14B shows a state where a cut is made in this target object, and FIG. 14C shows a state where the surface of this target object is unfolded onto a 2D planar figure. The skin-off scheme is a compression method according to which a cut is made in an object (subject) having an arbitrary shape to generate a cut path, the surface of the object is cut open and unfolded onto a specified 2D planar figure so that the cut path becomes the outer periphery (outline) in the specified 2D planar figure, 3D geometric information and optical information are correlated with points within the 2D planar figure, and a 2D image compression method is applied to this 2D planar figure. For example, in the example shown in FIG. 14, a cut path CU is generated by making a cut as shown by broken line in FIG. 14B in a spherical body SP polygonally approximated with triangular polygons shown in FIG. 14A. Subsequently, the surface of the spherical body SP is cut open along this cut path CU so that this cut path CU becomes the outer periphery of a 2D planar square SQ, whereby the polygonally approximated spherical body SP is unfolded onto the square SQ. Subsequently, the 3D geometric information and optical information are correlated with points within the 2D square SQ. In this way, the polygon mesh of the spherical body SP shown in FIG. 14A is unfolded onto the square SQ shown in FIG. 14C. Then, a 2D image compression method such as JPEG (Joint Photographic Expert Group) or MPEG (Motion Picture Experts Group) is applied to this square SQ, thereby compressing the polygon mesh data.

Here, upon correlating the 3D geometric information and optical information with the point within the 2D planar figure, the optical information is given to coordinates (x, y, z) of the vertices of the 3D polygon mesh, one vertex of the 3D polygon mesh is correlated with one pixel in the 2D planar figure, and the neighborhood relationship of the vertices of the 3D polygon mesh is directly represented by the neighborhood relationship of the pixels in the 2D planar figure. The optical information is, for example, texture data representing textures (patterns), and the texture data may contain luminance data and color data. By such representation, the 3D geometric information and optical information can be reproduced from the image data of the 2D planar figure.

It should be noted that the inventors of the present invention call this 3D image data compression method the skin-off scheme since the process of cutting the object surface open and unfolding the cut-open surface onto the 2D plane is similar to an operation of skinning off the object.

Patent Literature 1:

Japanese Unexamined Patent Publication No. 2002-109567

Non-Patent Literature 1:

“Generation, Editing and Visualization of 3D Video” by Takashi Matsuyama, Takeshi Takai, X. Wu and Shohei Nobuhara, Japan Virtual Reality Academy Thesis Magazine, Vol. 7, No. 4, pp. 521-532, 2002.12

Non-Patent Literature 2:

“Real-Time Generation and High Fidelity Visualization of 3D Video” by T. Matsuyama, X. Wu, T. Takai and S. Nobuhara, Proc. of MIRAGE2003, pp. 1-10, 2003.3

Non-Patent Literature 3:

“3D Video Recorder: A System for Recording and Playing Free-Viewpoint Video” by Wumlin Stephan, Lamboray Edouard, Staadt Oliver, Gross Markus, in Computer Graphics Forum 22(2), David Duke and Roberto Scopigno(eds.), Blackwell Publishing Ltd., Oxford, U.K., pp. 181-193,

Non-Patent Literature 4:

“A distributed System for real-time volume reconstruction” by E. Borovikov, L. Davis in: Proc. of International Workshop on Computer Architectures for Machine Perception, Padova, Italy, 2000, pp. 183-189

Non-Patent Literature 5:

“A real time system for robust 3D voxel reconstruction of Humanmotions” by G. Cheung, T. Kanade, in: Proc. Of Computer Vision and Pattern Recognition, South Carolina, USA, 2000, pp. 714-720

Non-Patent Literature 6:

“Skin-Off: Representation and Compression of 3D Video by Unfolding onto 2D planes” by Yosuke Katsura, Hitoshi Habe, Martin Boehme, Takashi Matsuyama in: Proc. of Picture Coding Symposium 2004, San Francisco, 2004.12

### DISCLOSURE OF THE INVENTION

An object of the present invention is to provide 3D image data compression system and method capable of efficiently compressing a data amount as compared to the conventional technique and obtaining a decompressed 3D image with little distortion in the above skin-off scheme, a 3D image data compression program using this 3D image data compression method, and a computer-readable recording medium storing this 3D image data compression program. Another object of the present invention is to provide a recording medium storing a 3D image data compressed by such a 3D image data compression method.

The inventors of the present invention found out that the compression efficiency of a 3D image data and a degree of distortion in a 3D image obtained by decompressing a compressed 3D image data differ if a texture distribution and stretch continuity are considered in the case of the above unfolding and correlation in the above skin-off scheme.

Accordingly, in the present invention, the above cut path is generated based on a texture distribution on the surface of a 3D image reproduced from a compressed data so as to reduce the distortion of the above 3D image. The geometric information and optical information of the 3D image data are correlated with points within a 2D planar figure based on the texture distribution on the surface of a 3D image so as to reduce the distortion of the 3D image reproduced from the compressed data.

Thus, the present invention is capable of efficiently compressing a data amount and obtaining a decompressed 3D image with little distortion as compared to the conventional technique.

### BRIEF DESCRIPTION OF THE DRAWINGS

FIG. 1 is a block diagram showing the construction of a 3D image data compression system according to one embodiment,

FIG. 2 is a flow chart showing the operation of the 3D image data compression system according to the embodiment,

FIG. 3 are graphs showing the influence by continuity in the stretch directions of adjacent polygons,

FIG. 4 are diagrams showing 3D images of polygon meshes and images of 2D planar figures,

FIG. 5 are diagrams and partial enlarged diagrams of 3D images obtained by decompressing compressed image data when viewed from directions of arrows shown in FIGS. 4A and 4C,

FIG. 6 are diagrams showing 3D images of polygon meshes,

FIG. 7 are diagrams showing cut paths in a 3D image of a Stanford bunny,

FIG. 8 are diagrams showing images of 2D planar figures corresponding to the Stanford bunny,

FIG. 9 are partial enlarged view of tail parts in 3D images obtained by decompressing the compressed data of the Stanford bunny,

FIG. 10 are diagrams showing cut paths in a 3D image of a maiko,

FIG. 11 are diagrams showing images of 2D planar figures corresponding to the maiko,

FIG. 12 are partial enlarged diagrams of head parts in 3D images obtained by decompressing the compressed data of the maiko,

FIG. 13 are partial enlarged diagrams of sash parts in 3D images obtained by decompressing the compressed data of the maiko, and

FIG. 14 are diagrams showing the skin-off scheme.

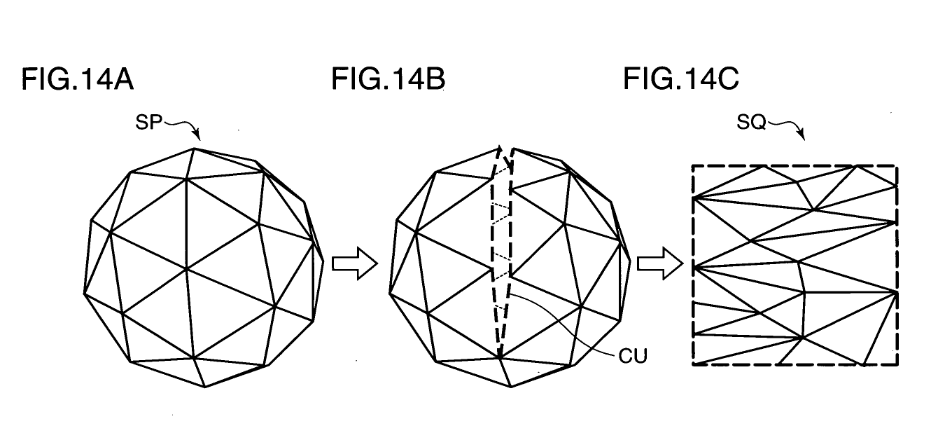

### BEST MODES FOR EMBODYING THE INVENTION

Hereinafter, one embodiment of the present invention is described with reference to the accompanying drawings. It should be noted that constructions identified by the same reference numerals are identical in the respective drawings and are not repeatedly described.

### Construction of the First Embodiment

A 3D image data compression system according to this embodiment is a system employing a compression method according to which a cut path is generated by making a cut in a polygon mesh polygonally approximating an object (subject) having an arbitrary shape, the polygon mesh is cut open along this generated cut path and unfolded onto a specified 2D planar figure, a polygon mesh data is correlated with points in the 2D planar figure, and a 2D image compression method is applied to this 2D planar figure.

This unfolding is performed such that the cut path becomes the outer periphery (outline) of the 2D planar figure, and this correlation is carried out to correlate texture data representing textures (patterns) with polygons of the polygon mesh generated from the polygon mesh data, correlate one vertex (x, y, z) of the 3D polygon mesh to one pixel p (x, y) in the 2D planar figure, and directly correlate the neighborhood relationship of the vertices of the polygon mesh to that of the pixels in the 2D planar figure.

Here, since polygons near the cut path are arranged at the outer peripheral part of the 2D planar figure at the time of the unfolding, they are largely stretched to be largely distorted, with the result that the textures of the polygons are also largely distorted. What should be noted in the first embodiment of the present invention is that the cut path is generated based on texture distributions of the polygons of the polygon mesh so as to reduce the distortion of the polygon mesh reproduced from a compressed polygon mesh data, and that the polygon mesh data is correlated with one pixel within the 2D planar figure based on the texture distributions of the polygons in the polygon mesh and continuity in stretch direction in the case of unfolding the polygon mesh onto the 2D planar figure so as to reduce the distortion reproduced from the compressed data of the polygon mesh data. Here, the distortion means a difference between the original polygon mesh and the polygon mesh reproduced from the compressed polygon mesh, and a large distortion means that this difference is large while a small distortion means that this difference is small. Thus, the smaller the distortion is, the more effectively the polygon mesh data is compressed.

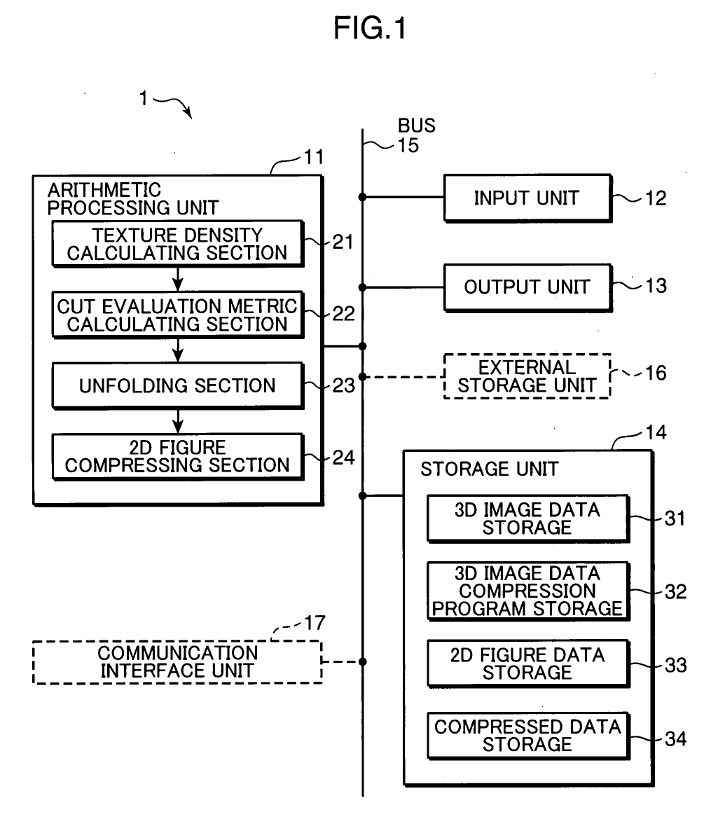

FIG. 1 is a block diagram showing the construction of the 3D image data compression system according to this embodiment. In FIG. 1, the 3D image data compression system 1 is, for example, provided with an arithmetic processing unit 11, an input unit 12, an output unit 13, a storage unit 14 and a bus 15.

The input unit 12 is a device used to input various commands such as compression starting instruction and various data such as polygon mesh data and texture data to be compressed in the 3D image data compression system 1 and is, for example, a keyboard, a mouse or the like. The polygon mesh data and the texture data are examples of 3D image data comprised of geometric information and optical information, and are obtained by polygonally approximating a target object. The polygon mesh data is an example of the geometric data and represents the positions of the respective vertices forming polygons in a 3D coordinate space. The texture data are an example of the optical information and represent the textures of polygons in a polygon mesh generated from the polygon mesh data. The texture data are correlated with the polygons and may contain luminance data representing luminance and color data representing colors, for example, RGB colors. It should be noted that the optical information may be given to the vertices P(x, y, z) of the 3D polygon mesh and the optical information between the vertices P may be interpolated based on the optical information at the vertices P. Polygons may have any arbitrary polygonal shapes such as triangular, rectangular, pentagonal and hexagonal shapes. However, since polygonal shapes other than triangular shapes can be represented by combinations of triangles, triangular shapes as basic elements of polygonal shapes are, for example, used in this embodiment. A technique for generating a polygon mesh data corresponding to a target object is a known technique, for example, disclosed in non-patent literatures 1 to 5 as described in the background art.

The output unit 13 is a device for outputting commands and data inputted from the input unit 12, a 2D planar figure obtained by unfolding a polygon mesh, and the file names and the like of the polygon mesh data compressed by this 3D image data compression system and is, for example, a display device such as a CRT display, an LCD, an organic EL display or a plasma display or a printing device such as a printer.

The storage unit 14 is functionally provided with a 3D image data storage 31 for storing the polygon mesh data and the texture data of the target object, a 3D image data compression program storage 32 for storing the 3D image data compression program according to the present invention for compressing 3D image data, a 2D figure data storage 33 for storing 2D planar figure data, and a compressed data storage 34 for storing compressed data, and stores various programs and various data such as data generated during the execution of the various programs. The storage unit 14 includes, for example, a volatile storage device such as a RAM (Random Access Memory) that serves as a so-called working memory for the arithmetic processing unit 11, and a nonvolatile storage device such as a ROM (Read Only Memory) or a rewritable EEPROM (Electrically Erasable Programmable Read Only Memory).

The 2D planar figure data is the data of a 2D planar figure obtained by cutting the polygon mesh of the target object open and unfolding it onto the 2D planar figure and having the polygon mesh data and the texture data correlated therewith. The compressed data is a data obtained by applying a 2D image compression method to this 2D planar figure, i.e. the compression data of the polygon mesh data and the texture data. The 2D image compression method is JPEG, PNG (Portable Network Graphics) or the like for still image data and is, for example, MPEG-1, MPEG-2, MPEG-4, H.263, H.261, H.264, Motion JPEG or the like for moving image data.

The arithmetic processing unit 11 includes, for example, a microprocessor and its peripheral circuits and is functionally provided with a texture density calculating section 21 for calculating texture densities T(s) to be described later, a cut evaluation metric calculating section 22 for calculating cut evaluation metrics D(e) to be described later, an unfolding section 23 for generating a cut path based on the texture densities T(s) of the polygons in the polygon mesh, cutting the surface of the polygon mesh open and unfolding it onto a 2D planar figure so that this cut path becomes the outer periphery of the 2D planar figure having a specified shape and correlating the polygon mesh data with one pixel within the 2D planar figure based on evaluation metrics m to be described later, and a 2D planar figure compressing section 24 for generating the compressed polygon mesh data by compressing the 2D planar figure by the 2D image compression method. Further, the arithmetic processing unit 11 controls the input unit 12, the output unit 13 and the storage unit 14 by the functions thereof in accordance with a control program.

It should be noted that the specified shape may be any arbitrary shape such as a triangular shape, a rectangular shape, a pentagonal shape, a hexagonal shape or another polygonal shape or a round shape such as a circular shape or an elliptic shape provided that it is closed. In this embodiment, a square shape is adopted in consideration of such a 2D image compression method as to be able to effectively compress the 2D planar figure. These texture density calculating section 21, cut evaluation metric calculating section 22 and the unfolding section 23 are examples of an unfolding/projecting section, and the 2D planar figure compressing section 24 is an example of a figure compressing section.

These arithmetic processing unit 11, input unit 12, output unit 13 and storage unit 14 are connected with each other via the bus 15 so as to be able to exchange data with each other.

Such a 3D image data compression system 1 can be constructed, for example, by a computer, more specifically by a notebook or desktop personal computer.

If necessary, the 3D image data compression system 1 may further include an external storage unit 16 and/or a communication interface unit 17 as shown by broken line. The external storage unit 16 is a device for reading and/or writing data in and/from a recording medium such as a flexible disk, a CD-ROM (Compact Disc Read Only Memory), a CD-R (Compact Disc Recordable) or DVD-R (Digital Versatile Disc Recordable) and is, for example, a flexible disk drive, a CD-ROM drive, a CD-R drive or a DVD-R drive. The communication interface unit 17 is an interface circuit connected with a network such as a local area network or an external network (e.g., Internet) and adapted to transmit and receive communication signals to and from other communication terminals via this network, and generates a communication signal based on data from the arithmetic processing unit 11 in accordance with a communication protocol of the network and converts a communication signal from the network into a data of such a format processable by the arithmetic processing unit 11.

Here, if various programs such as the 3D image data compression program and various data such as the polygon mesh data are not stored, the 3D image data compression system 1 may be constructed such that these programs and data can be installed in the storage unit 14 from a recording medium storing these via the external storage unit 16 or that these programs and data can be downloaded from a server (not shown) administering the various programs and the various data via the network and the communication interface unit 17.

Next, the operation of this embodiment is described.

### Operation of the First Embodiment

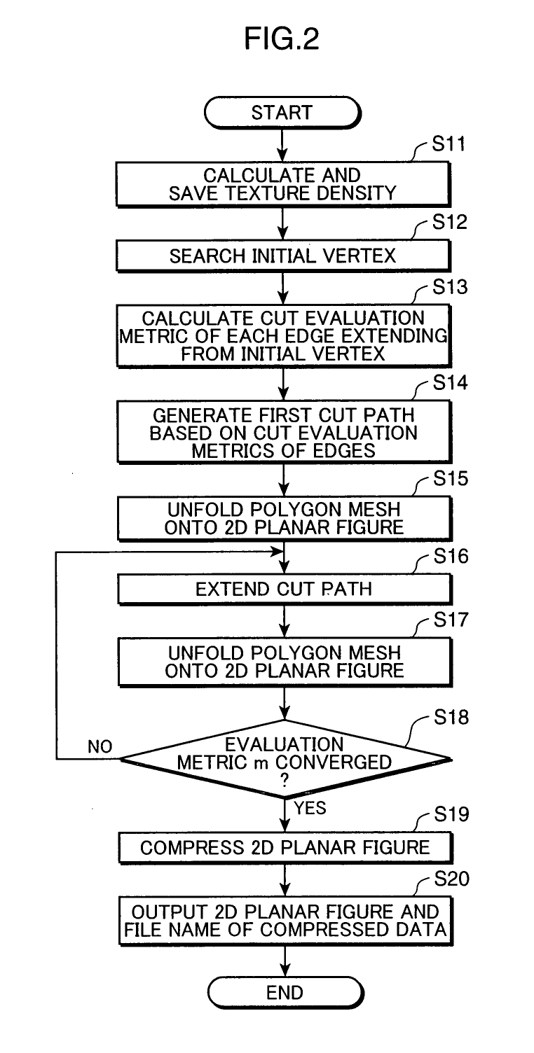

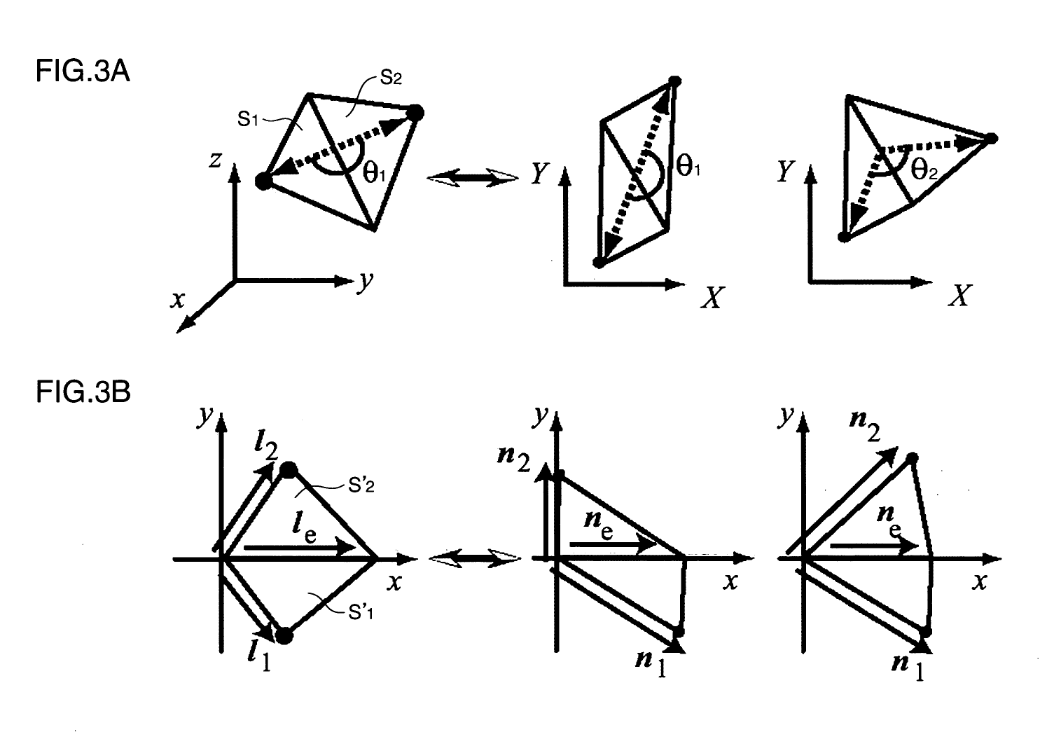

FIG. 2 is a flow chart showing the operation of the 3D image data compression system according to this embodiment, and FIG. 3 are diagrams showing the influence by continuity in the stretch directions of adjacent polygons, wherein FIG. 3A shows the continuity in the stretch directions of the adjacent polygons and FIG. 3B shows coordinate axes of continuity evaluation metrics mₛ(e).

In FIG. 2, the 3D image data compression program is read from the 3D image data compression program storage 32 of the storage unit 14 and executed. If a user, for example, inputs the file name of a polygon mesh data and inputs a compression start instruction command by means of the input unit 12 in order to compress a texture-mapped polygon mesh, the texture density calculating section 21 of the arithmetic processing unit 11 first calculates the texture density T(s) of each polygon of the polygon mesh based on the polygon mesh data and the texture data stored in the 3D image data storage 31 of the storage unit 14 and saves the polygons s and their texture densities T(s) in correspondence in the storage unit 14 (Step S11).

As described above, in this embodiment of the present invention, the cut path CU is generated and the polygon mesh data is correlated with one pixel in the 2D planar figure so as to reduce distortion in the case of reproducing a texture-mapped polygon mesh from a compressed data. Thus, it is necessary to evaluate texture distributions of the polygons. Accordingly, the 3D image data compression system 1 first calculates the texture density T(s) representing the degree of complexity of the texture of each polygon s as an evaluation metric for evaluating the texture distribution of the polygon. The texture distribution T(s) is, for example, an average value of spatial differentials at the respective pixels on the polygon in this embodiment and is defined by equation (1).

$$T ( s ) = \frac{1}{{A}_{S}} {\int }_{S}^{} \sqrt{ⅆ {x ( p )}^{2} + ⅆ {y ( p )}^{2} ⅆ p} \qquad ( 1 )$$

Here, s denotes the polygon, Aₛ the area of the polygon and p a pixel on the polygon, and dx(p), dy(p) denote the spatial differentials of the texture at the pixel p.

Subsequently, based on the polygon mesh data stored in the 3D image data storage 31 of the storage unit 14, the unfolding section 23 searches a point of the polygon mesh where the shape change is largest, e.g. a most pointed vertex (initial vertex) out of the vertices of the polygon mesh (Step S12). This search is conducted, for example, as follows. First, the unfolding section 23 calculates a radius of curvature of a curve formed by a target vertex and vertices at the opposite sides of the target vertex. Since there are normally a plurality of radii of curvature for one target vertex, the smallest radius of curvature is set as the radius of curvature at this target vertex. The unfolding section 23 sets the thus obtained vertex having the smallest one of the radii of curvature of the vertices as an initial vertex.

Subsequently, the unfolding section 23 calculates the cut evaluation metric D(e) of each edge e forming this initial vertex (edge e having the initial vertex at one end) using the cut evaluation metric calculating section 22 in order to obtain a first cut path CU₀ (Step S13). As described later, a final cut path CU is generated by being gradually extended from the first cut path CU₀ by the repeat operation repeated until reaching convergence. The cut paths CU generated by the repetition of the repeat operation are expressed by suffixes. For example, the first cut path is expressed by CU₀ and the next cut path is expressed by CU₁.

Here, if the cut path CU is generated in the polygon x having a small texture distribution T(s), the influence on the decompressed image can be suppressed even if the polygon s is stretched by the unfolding. Since the cut path CU is actually defined not in the polygon s, but at an edge e that is a boundary between polygons s₁ and s₂, it is necessary to assign the texture distribution T(s₁) of the polygon s₁ and the texture distribution T(s₂) of the polygon s₂ to the edge e. Thus, in this embodiment, the cut evaluation metric D(e) of the edge e defined by a sum of the texture densities T(s₁), T(s₂) of the polygon s₁, s₂ is introduced as shown in equation (2). This cut evaluation metric D(e) of the edge e serves as an evaluation metric for evaluation along which edge e a cut should be made.
D(e)=T(s₁)+T(s₂) (2)

Subsequently, the unfolding section 23 searches the edge e having the smallest cut evaluation metric D(e) since the cut evaluation metrics D(e) are defined as in equation (2), and sets the thus searched edge e having the smallest cut evaluation metric D(e) as the first cut path CU₀ (Step S14). By setting the edge e having the smallest cut evaluation metric D(e) as the first cut path CU₀ in this way, the polygons s having smaller texture distributions can be arranged at the outer peripheral part of the figure. Therefore, even if the polygons s are stretched by the unfolding, the influence on the textures by the polygons s can be reduced.

Subsequently, the unfolding section 23 unfolds the polygon mesh onto a 2D planar figure having a specified shape along the first cut path CU₀ (Step S15). This unfolding is carried out such that the first cut path CU₀ becomes the outer periphery of the 2D planar figure, and one vertex of the polygon mesh is correlated with one pixel in the 2D planar figure while the neighborhood relationship of the vertices in the polygon mesh is represented as it is by the neighborhood relationship of pixels in the 2D planar figure.

If a function for correlating one vertex of this polygon mesh with one pixel in the 2D planar figure, i.e. a function representing the correspondence between one vertex of the polygon mesh and one pixel in the 2D planar figure is called a projection function G, this projection function G may be optimized based on the evaluation metrics m in view of the texture distributions of the polygons s in order to unfold the polygon mesh such that the distortion of the texture-mapped polygon mesh reproduced from the compressed data is minimized.

Here, even if the polygons s are stretched by the unfolding, the influence of such deformations can be reduced if the texture densities T(s) of the polygons s are small. Thus, geometric stretch metrics m_{G}(s) representing stretching degrees of the polygons s are first introduced into the evaluation metrics m after being weighted based on the texture densities T(s) by a weighting function m_{T}(s).

$$\begin{matrix}{m}_{G} ( s ) = \sqrt{\frac{( {Γ}^{2} + {γ}^{2} )}{2}} , {L}^{∞} ( T ) = Γ & ( 3 ) \\ Γ = \sqrt{\frac{1}{2} ( ( a + c ) + \sqrt{{( a - c )}^{2} + 4 {b}^{2} )}} & ( 4 \text{-} 1 ) \\ γ = \sqrt{\frac{1}{2} ( ( a + c ) - \sqrt{{( a - c )}^{2} + 4 {b}^{2} )}} & ( 4 \text{-} 2 )\end{matrix}$$

Here, Γ is given by equation (4-1) and γ is given by equation (4-2). If h denotes a transformation equation for transforming an arbitrary point on a 2D triangular mesh corresponding to a polygon (triangle) of the 3D polygon mesh into a point in this 3D space and hu(=dh/du), hv(=dh/dv) respectively denote partial differentials of a 2D coordinate system uv of the transformation equation h, a=hu·hu, b hu·hv and c=hv·hv. It should be noted that the geometric stretch metric m_{G}(s) is a texture stretch metric in “Texture Mapping Progressive Meshes” by Pedro V. Sander, John Snyder, Steven J. Gortler, Huguges Hoppe, ACM SIGGRAPH 2001, pp. 409-416, 2001.

By simulation experiments, the inventors of the present invention found out that, if the weighting function m_{T}(s) was defined only by the texture densities T(s) of the polygons s, values might largely vary among neighboring polygons and, as a result, the textures might be largely distorted if a texture-mapped polygon mesh was generated by unfolding a texture-mapped polygon mesh onto a 2D planar figure and then reproducing it again. Accordingly, after texture densities T(t) of polygons t around the polygon s are weighted, the weighting function m_{T}(s) was defined by calculating a sum total of the weighted texture densities T(t). In other words, the weighting function m_{T}(s) is defined by equation (5).

$${m}_{T} ( s ) = {\sum }_{t ∈ N ( s )} f ( t , s ) \times T ( t ) \qquad ( 5 )$$

N(s) is a set of the polygon t neighboring the polygon s, and the weight f of the texture density T(t) is such a function as to take a larger value as a distance between the polygon s and the polygon t decreases. The distance between the polygon s and the polygon t is a distance between the centers of gravity of the surfaces of the respective polygons t, s.

On the other hand, by simulation experiments, the inventors of the present invention founds out that the textures of the polygon mesh reproduced from the compressed data might be largely distorted by the unfolding depending on the stretch directions of the adjacent polygons s₁, s₂. Specifically, if the polygons s₁, s₂ neighboring at an angle θ₁ in the polygon mesh as shown on the left side of FIG. 3A is unfolded onto a 2D planar figure at the angle θ₁ as shown in the middle of FIG. 3A, a sampling rate on the polygon mesh upon the final imaging does not largely vary on a boundary line between the neighboring polygons s₁, s₂, wherefore image quality disturbance can be suppressed also on this boundary line. In other words, the distortion can be suppressed. On the other hand, if the polygons s₁, s₂ adjacent to each other at the angle θ₁ in the polygon mesh as shown on the left side of FIG. 3A is unfolded onto the 2D planar figure at an angle θ₂ different from θ₁ as shown on the right side of FIG. 3A, the sampling rate on the polygon mesh upon the final imaging varies on the boundary line between the neighboring polygons s₁, s₂, wherefore the image quality is disturbed. In other words, the distortion becomes larger. Thus, the continuity evaluation metric m (e) for evaluating the continuity in the stretch direction is defined and further introduced into the evaluation metric m. This continuity evaluation metric mₛ(e) is defined as in equation (6) by projecting the polygons s₁, s₂ adjacent on the polygon mesh to a 2D plane as shown on the left side of FIG. 3B and rotating projections s′₁, s′₂ of the polygons s₁, s₂ on the 2D plane as shown in the middle of FIG. 3(B) so that the shared edge correspond to an X-axis.

$${m}_{s} ( e ) = ‖ \frac{1}{‖ le ‖} ( {l}_{1} + {l}_{2} ) - \frac{1}{‖ ne ‖} ( {n}_{1} + {n}_{2} ) ‖ \qquad ( 6 )$$

Here, le denotes a vector representing the edge e shared by the adjacent polygon s₁, s₂; l₁ a vector representing the edge e of the polygon s₁ having one end thereof located at the starting point of the vector le; l₂ a vector representing the edge e of the polygon s₂ having one end thereof located at the starting point of the vector le; and ne, n₁ and n₂ vectors corresponding to le, l₁ and l₂ on the 2D plane.

As can be known from the right side of FIG. 3B, minimizing the continuity evaluation metric mₛ(e) corresponds to keeping (l₁+l₂) and (n₁+n₂) equal to each other in a normalized domain.

By the above, the evaluation metric m is defined by equation (7).

$$m = {α}_{1} {\sum }_{s} {m}_{T} ( s ) \times {m}_{G} ( s ) + {α}_{2} {\sum }_{s} {m}_{s} ( e ) \qquad ( 7 )$$

Here, α₁, α₂ are parameters for balancing the respective evaluation metrics Σm_{T}(s)×m_{G}(s) and Σmₛ(e) and, for example, determined by simulation experiments.

Step S15 using such evaluation metrics m is described more specifically. In order to avoid local minima without being able to obtain true optimal solutions, using a simplified polygon mesh obtained by skipping the vertices of the polygon mesh, the unfolding section 23 obtains such a projection function G as to minimize a sum total of the evaluation metrics m while displacing positions on the 2D planar figure corresponding to the vertices of this polygon mesh, thereby obtaining an optimal projection function G for the simplified polygon mesh. Subsequently, the unfolding section 23 calculates to which positions on the 2D planar figure vertices around a vertex to be added correspond using this optimal projection function G and adds the vertex such that this vertex is projected at a middle point of the surrounding vertices. Subsequently, using a polygon mesh having the vertex added thereto, the unfolding section 23 obtains such a projection function G as to minimize a sum total of the evaluation metrics m while displacing positions on the 2D planar figure corresponding to the vertices of this polygon mesh, thereby obtaining an optimal projection function G corresponding to the polygon mesh having the vertex added thereto. This addition of the vertex and the optimization of the projection function G corresponding to the polygon mesh having the vertex added thereto are successively repeated until all the skipped vertices are added. By such a process, the 2D planar figure can be obtained by unfolding the polygon mesh along the first cut path CU₀ which is the projection of the respective vertices of the polygon mesh to the pixels within the 2D planar figure.

Thereafter, the unfolding section 23 obtains the final cut path CU by extending the cut path CU from the first cut path CU₀ until the evaluation metrics m converge before and after the extension of the cut path CU.

Specifically, following Step S15, the unfolding section 23 extends a cut path CUₙ₋₁ using the projection function G for the unfolding onto the 2D planar figure along the cut path CUₙ₋₁ to obtain a new cut path CUₙ (Step S16).

More specifically, the unfolding section 23 calculates m_{G}(s) using the projection function G for the unfolding onto the 2D planar figure along the cut path CUₙ₋₁ and searches the polygon s having the largest m_{G}(s). Subsequently, the unfolding section 23 calculates the cut evaluation metrics D(e) and distances d(e) to the cut path CUₙ₋₁ for all the edges e of the polygon mesh excluding the edges e of the cut path CUₙ₋₁ and the edges e of the polygon s having the largest M_{G}(s). Subsequently, the unfolding section 23 calculates β₁×D(e)+β₂×d(e) for all the edges e each having one end thereof located at the corresponding vertex of the polygon s having the largest m_{G}(s) excluding the edges e of the polygon s having the largest m_{G}(s) and searches the edge e having the smallest β₁×D(e)+β₂×d(e). β₁, β₂ are parameters for balancing the cut evaluation metrics D(e) and the distances d(e) and, for example, determined by simulation experiments. Subsequently, the unfolding section 23 calculates β₁×D(e)+β₂×d(e) for the edges e each having one end thereof located at the other end of the searched edge e, and searches the edge e having the smallest β₁×D(e)+β₂×d(e). This search is repeated until reaching the cut path CUₙ₋₁. The cut path CUₙ₋₁ is extended from the polygon s having the largest m_{G}(s) using the respective edges e having thus obtained as cuts, thereby obtaining a new cut path CU₀.

Subsequently, the unfolding section 23 unfolds the polygon mesh onto the 2D planar figure along the cut path CUₙ (Step S17). This unfolding is similar to the one in Step S15.

Using a simplified polygon mesh obtained by skipping the vertices of the polygon mesh, the unfolding section 23 obtains such a projection function G as to minimize a sum total of the evaluation metrics m while displacing positions on the 2D planar figure corresponding to the vertices of this polygon mesh, thereby obtaining an optimal projection function G for the simplified polygon mesh. Subsequently, the unfolding section 23 calculates to which positions on the 2D planar figure vertices around a vertex to be added correspond using this optimal projection function G and adds the vertex such that this vertex is projected at a middle point of the surrounding vertices. Subsequently, using a polygon mesh having the vertex added thereto, the unfolding section 23 obtains such a projection function G as to minimize a sum total of the evaluation metrics m while displacing positions on the 2D planar figure corresponding to the vertices of this polygon mesh, thereby obtaining an optimal projection function G for the polygon mesh having the vertex added thereto. This addition of the vertex and the optimization of the projection function G corresponding to the polygon mesh having the vertex added thereto are successively repeated until all the skipped vertices are added. By such a process, the 2D planar figure can be obtained by unfolding the polygon mesh along the new cut path CUₙ which is the projection of the respective vertices of the polygon mesh to the pixels in the 2D planar figure.

Subsequently, the unfolding section 23 judges whether or not the evaluation metrics m have converged (Step S18). Specifically, the unfolding section 23 judges whether or not the evaluation metric mₙ in the case of the cut path CUₙ and the evaluation metric mₙ₋₁ in the case of the cut path CUₙ₋₁ before the extension to the cut path CUₙ substantially agree with each other. If the evaluation metrics m are judged not to have converged yet (if the evaluation metrics mₙ and mₙ₋₁ do not substantially agree, NO), the unfolding section 23 returns to Step S16 in order to extend the cut path CUₙ using the projection function G for the unfolding onto the 2D planar figure along this cut path CUₙ and to obtain a new cut path CUₙ₊₁.

On the other hand, if the evaluation metrics m have converted ((if the evaluation metrics mₙ and mₙ₋₁ substantially agree, YES), the unfolding section 23 saves the thus obtained 2D planar figure data in the 2D figure data storage 33 of the storage unit 14; finishes the unfolding/projecting process of unfolding the texture-mapped polygon mesh onto the 2D planar figure along the cut path CU and projecting the respective vertices of the polygon mesh to the pixels in the 2D planar figure; compresses this 2D planar figure using the 2D planar figure compressing section 24; and saves this compressed data of the texture-mapped polygon mesh in the compressed data storage 34 of the storage unit 14 while assigning the file name thereto (Step S19). Since the compressed data capable of generating a polygon mesh with little distortion after decompression is efficiently compressed, more polygon data and texture data can be saved in the compressed data storage 34 having the same capacity.

Further, the unfolding section 23 outputs the thus generated 2D planar figure obtained by unfolding the texture-mapped polygon mesh and the file name of the compressed data to the output unit 13 (Step S20).

As described above, since the 3D image data compression system 1 according to the first embodiment sets the edge e having the smallest cut path evaluation metric D(e) for evaluating the texture distribution of the polygon s as the first cut path CU₀, the polygons s having low texture densities T(s), i.e. having small texture distributions can be arranged at the outer peripheral part of the figure in the case of unfolding onto the 2D planar figure. Thus, even if the polygon mesh is stretched upon being unfolded onto the 2D plane, the influence thereof on the textures of the polygon mesh after the decompression can be reduced. Therefore, distortions in the texture-mapped polygon mesh after the decompression can be reduced in appearance. Further, since the 3D image data compression system 1 according to the first embodiment described above optimizes the projection function G in such a manner as to minimize the sum total of the evaluation metrics m for evaluating the stretching degree upon the unfolding weighted by the texture distributions and the continuity in the stretch direction upon the unfolding and to let the evaluation metrics m converge, distortions in the texture-mapped polygon mesh after the decompression can be reduced. Further, since the polygon mesh is unfolded onto the 2D planar figure such that the distortions in the texture-mapped polygon mesh after the decompression are reduced as described above, an existing compression method can be utilized and data can be efficiently compressed. Accordingly, the 3D image data compression system 1 according to the first embodiment can efficiently compress the data amount and provide decompressed images with little distortion.

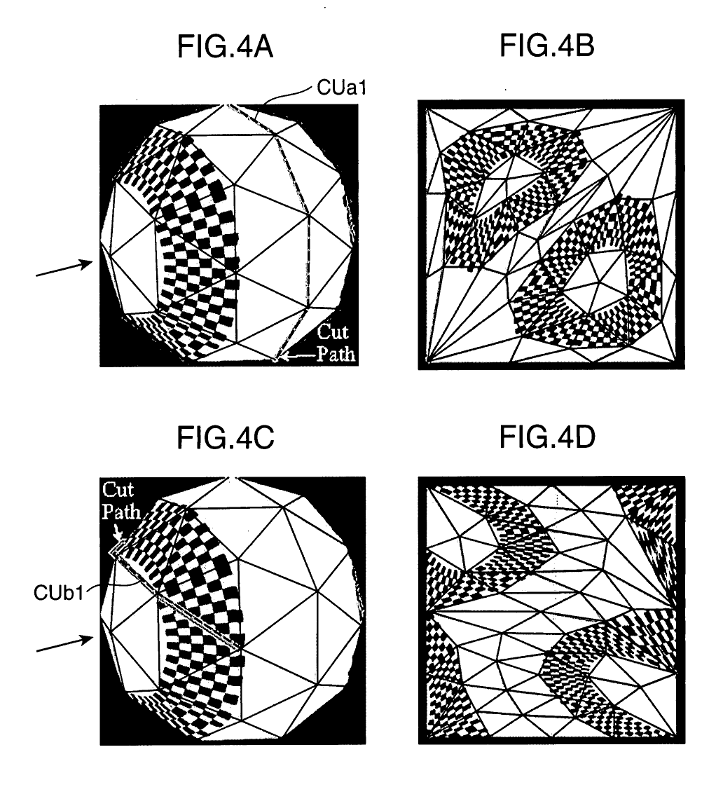

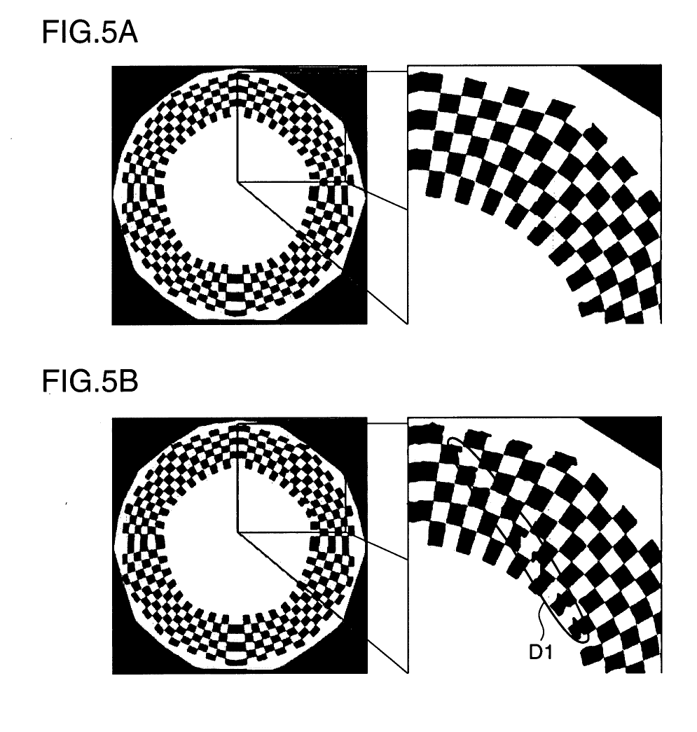

Next, a comparative example is described. FIG. 4 are diagrams showing a 3D image of a polygon mesh and images of 2D planar figures, wherein FIG. 4A shows the 3D image and a cut path in the case of applying the present invention, FIG. 4B shows the image of the 2D planar figure in the case of applying the present invention, FIG. 4C shows the 3D image and a cut path in the case of applying a background art, and FIG. 4D shows the image of the 2D planar figure in the case of applying the background art. FIG. 5 are diagrams and partial enlarged diagrams of 3D images obtained by decompressing compressed image data when viewed from directions of arrows shown in FIGS. 4A and 4C, wherein FIG. 5A are a diagram (left side) and a partial enlarged diagram (right side) in the case of applying the present invention, i.e. when the 3D image obtained by decompressing the compressed image data of the 2D planar figure shown in FIG. 4B is viewed in the direction of arrow shown in FIG. 4A, and FIG. 5B are a diagram (left side) and a partial enlarged diagram (right side) in the case of applying the background art, i.e. when the 3D image obtained by decompressing the compressed image data of the 2D planar figure shown in FIG. 4D is viewed in the direction of arrow shown in FIG. 4C. It should be noted that each partial enlarged diagram represents one quarter at the right upper side of the 3D image when viewed in the direction of arrow shown in FIG. 4A or 4C.

The target object has a spherical shape and, if it is assumed that intersections of an axis passing the center of this object and the surface of the object are called a north pole and a south pole and a line of intersection of a plane passing the center and normal to the axis and the surface of the object is called an equator, strip-shaped checkered patterns are formed on the surface of the object between the north pole and the equator and between the south pole and the equator.

If this target object is polygonally approximated by 80 right triangular polygons, the 3D images shown in FIGS. 4A and 4C are obtained and polygon mesh data and texture data are obtained.

Here, if the present invention is applied, a cut path CUa1 is formed along edges shared by the polygons free from the checkered patterns, i.e. edges shared by the polygons having no texture distribution as shown by broken line in FIG. 4A. On the other hand, if the background art is applied, a cut path CUb1 is formed, for example, to include edges of the polygons with the checkered patterns located at one or both sides shown by broken line in FIG. 4C.

As a result, the cut path CUa1 becomes the outer periphery of the square image of the 2D planar figure in the case of applying the present invention. Thus, patterns in the image of the 2D planar figure corresponding to the strip-shaped checkered patterns in the 3D image are distanced from the square outer peripheral part, i.e. located in the middle part of the square. Therefore, the patterns in the image of the 2D planar figure corresponding to the strip-shaped checkered patterns in the 3D image have relatively small stretching degrees. Accordingly, the 3D image obtained by compressing the compressed data of this 2D planar figure image is an image whose checkered patterns are substantially free from distortions as shown in FIG. 5A.

On the other hand, the cut path CUb1 becomes the outer periphery of the square image of the 2D planar figure in the case of applying the background art. Thus, patterns in the image of the 2D planar figure corresponding to the strip-shaped checkered patterns in the 3D image are formed also at the square outer peripheral part. Therefore, the patterns in the image of the 2D planar figure corresponding to the strip-shaped checkered patterns in the 3D image have relatively large stretching degrees. Accordingly, the 3D image obtained by compressing the compressed data of this 2D planar figure image is an image whose checkered patterns are distorted as shown in FIG. 5B. Particularly, a notable distortion can be seen in a part D1 encircled in FIG. 5B.

As shown in this example, 3D images obtained by decompressing the compressing data through the application of the present invention have less distortion as compared to the background art.

Next, another embodiment is described.

### Second Embodiment

In the first embodiment described above, the 3D image data compression system 1 generates the cut path based on the texture distributions of the polygons of the polygon mesh so as to reduce the distortion of the polygon mesh reproduced from the compressed data of the polygon mesh data and correlates the polygon mesh data with one pixel within the 2D planar figure based on the texture distributions of the polygons of the polygon mesh and the continuity in the stretch direction in the case of unfolding the polygon mesh onto the 2D planar figure so as to reduce the distortion of the polygon mesh reproduced from the compressed data of the polygon mesh data.

Here, depending on the shape and texture distributions of a target object, a 3D image obtained by decompressing a compressed data in the case of not considering the continuity in the stretch direction upon unfolding a polygon mesh onto a 2D planar figure might not look largely different to human eyes (difference cannot be sensed by human vision) from a 3D image obtained by decompressing a compressed data in the case of considering the continuity in the stretch direction. Particularly, since a plurality of frames are displayed within one second for moving images, such a difference is even more difficult to recognize by human eyes.

Accordingly, in the second embodiment, a 3D image data compression system generates a cut path based on texture distributions of polygons of a polygon mesh so as to reduce the distortion of a polygon mesh reproduced from a compressed polygon mesh data and correlates the polygon mesh data with one pixel within a 2D planar figure based on the texture distributions of the polygons of the polygon mesh so as to reduce the distortion of the polygon mesh reproduced from the compressed polygon mesh data.

To this end, the construction and operation of the 3D image data compression system according to the second embodiment are similar to those of the 3D image data compression system 1 according to the first embodiment except that the unfolding section 23, of the arithmetic processing unit 11 uses evaluation metrics m defined by equation (8) instead of those defined by equation (7) in Step S15. Therefore, the construction and operation of the 3D image data compression system according to the second embodiment are not described.

$$m = {\sum }_{s} ( ( ɛ \times {m}_{T} ( s ) + 1 ) \times {m}_{G} ( s ) ) \qquad ( 8 )$$

Here, ε is a parameter for balancing the respective evaluation metrics Σm_{T}(s)×m_{G}(s) and Σm_{G}(e) and, for example, determined by a simulation experiment. This equation (8) expresses that the evaluation metric m is defined by a geometric stretch metric m_{G}(s) weighted by a weighting function m_{T}(s) based on a texture densities T(s), and by the weighting function m_{T}(s).

Since the 3D image data compression system according to the second embodiment sets an edge e having the smallest cut path evaluation metric D(e) for evaluating the texture distribution of the polygon s as a first cut path CU₀, the polygons s having low texture densities T(s), i.e. having small texture distributions can be arranged at the outer peripheral part of the figure in the case of unfolding onto the 2D planar figure. Thus, even if a polygon mesh is stretched upon being unfolded onto a 2D plane, the influence thereof on the textures of the polygon mesh after the decompression can be reduced. Therefore, distortions in the texture-mapped polygon mesh after the decompression can be reduced in appearance. Further, since the 3D image data compression system according to the second embodiment described above optimizes the projection function G in such a manner as to minimize a sum total of the evaluation metrics m and to let the evaluation metrics m converge, distortions in the texture-mapped polygon mesh after the decompression can be reduced. Further, since the polygon mesh is unfolded onto the 2D planar figure such that the distortions in the texture-mapped polygon mesh after the decompression are reduced as described above, an existing compression method can be utilized and data can be efficiently compressed. Accordingly, the 3D image data compression system according to the second embodiment can efficiently compress the data amount and provide decompressed images with little distortion.

Further, since the continuity in the stretch direction in the case of unfolding the polygon mesh onto the 2D planar figure is not considered, information processing can be simplified and processing speed can be increased in the 3D image data compression system according to the second embodiment.

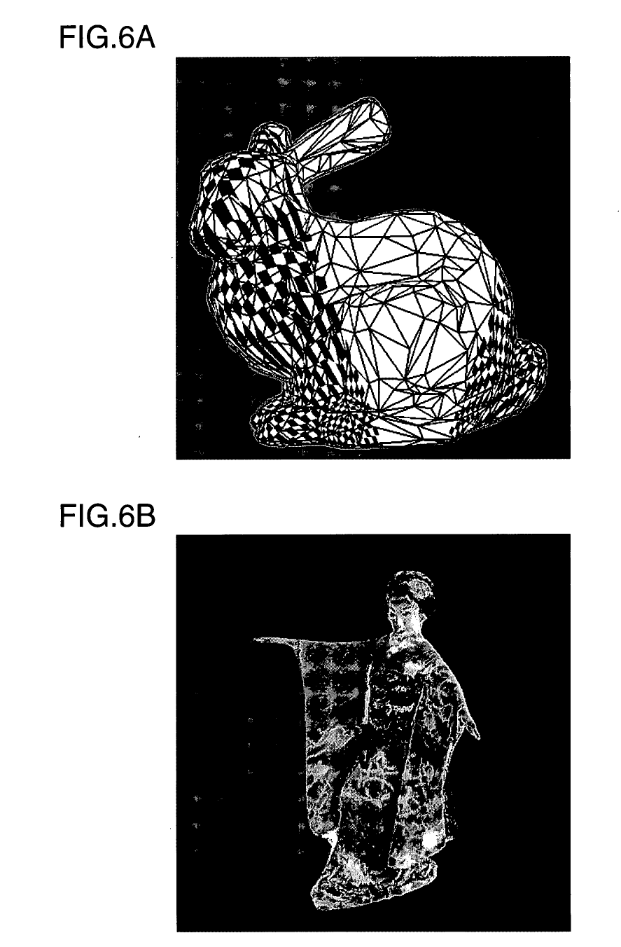

Next, comparative examples are described. FIG. 6 are diagrams showing 3D images of polygon meshes, wherein FIG. 6A shows a Stanford bunny and FIG. 6B shows a maiko.

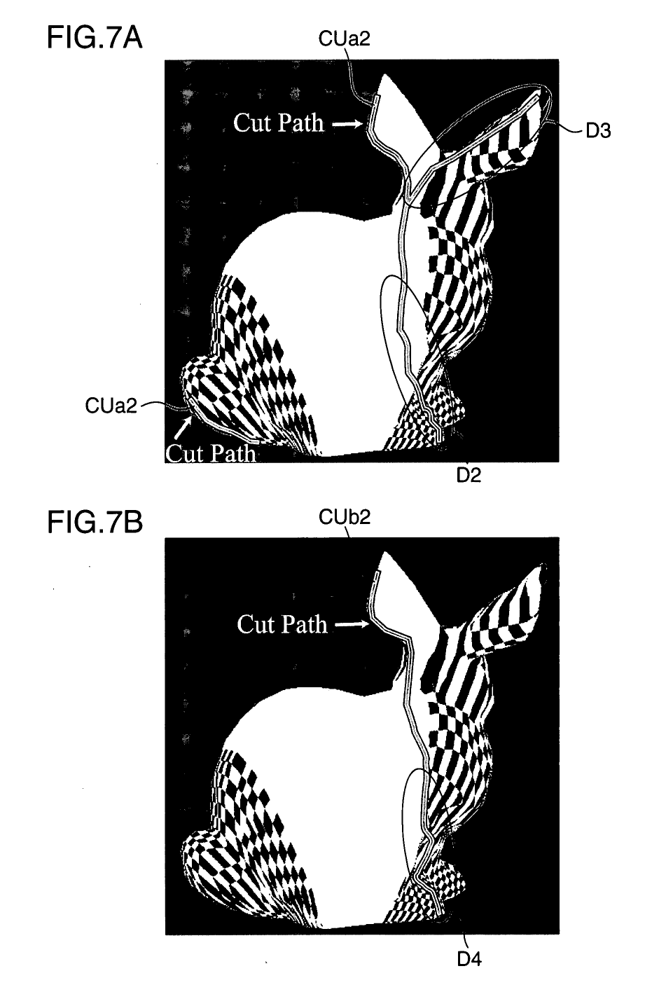

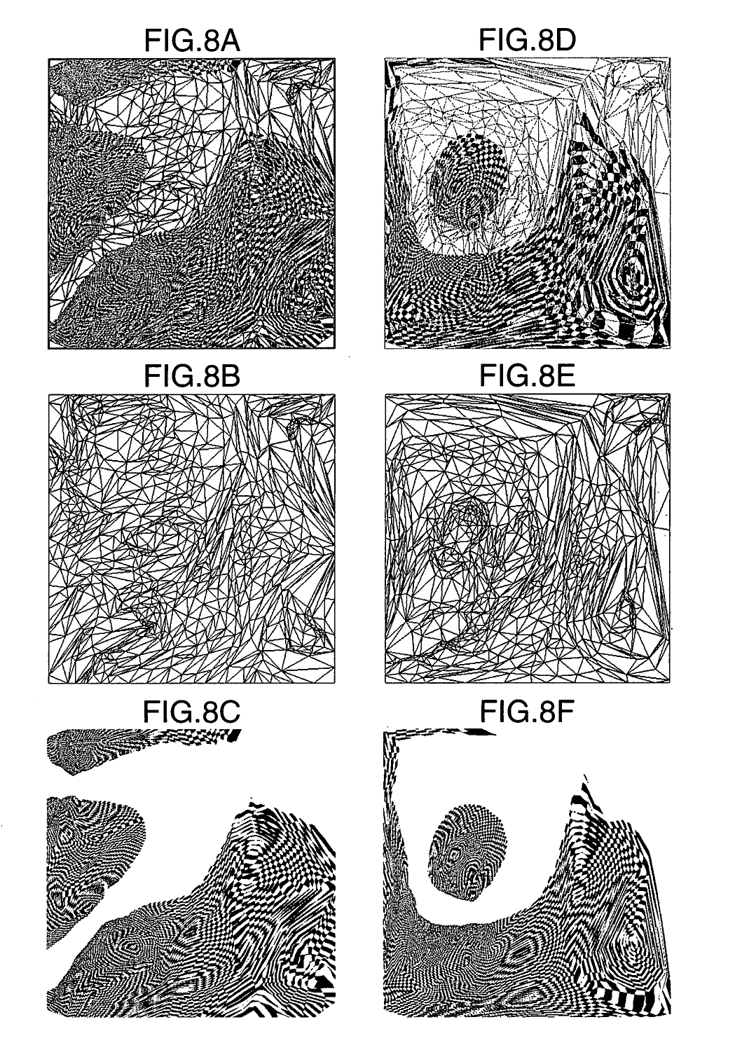

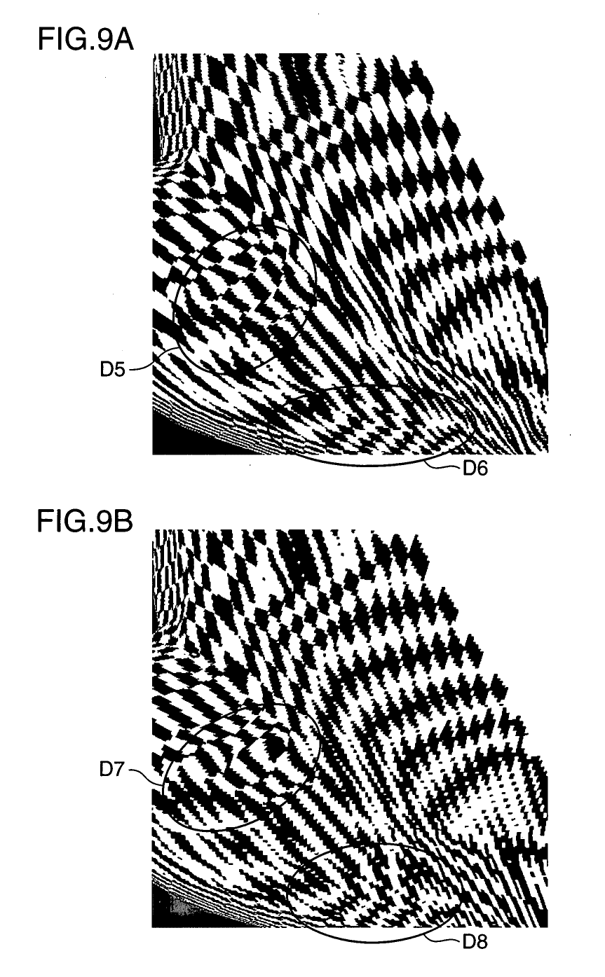

FIG. 7 are diagrams showing cut paths in the 3D image of the Stanford bunny, wherein FIG. 7A shows the case of applying the present invention and FIG. 7B shows the case of applying a background art. FIG. 8 are diagrams showing images of 2D planar figures of the Stanford bunny, wherein FIG. 8A shows the image of the 2D planar figure in the case of applying the present invention, FIG. 8B shows a mesh in the 2D planar figure image in the case of applying the present invention, FIG. 8C shows texture in the 2D planar figure image in the case of applying the present invention, FIG. 8D shows the image of the 2D planar figure in the case of applying the background art, FIG. 8E shows a mesh in the 2D planar figure image in the case of applying the background art, and FIG. 8F shows texture in the 2D planar figure image in the case of applying the background art. FIG. 9 are partial enlarged diagrams of tail parts of the 3D images obtained by decompressing compressed data of the Stanford bunny, wherein FIG. 9A shows the case of applying the present invention and FIG. 9B shows the case of applying the background art.

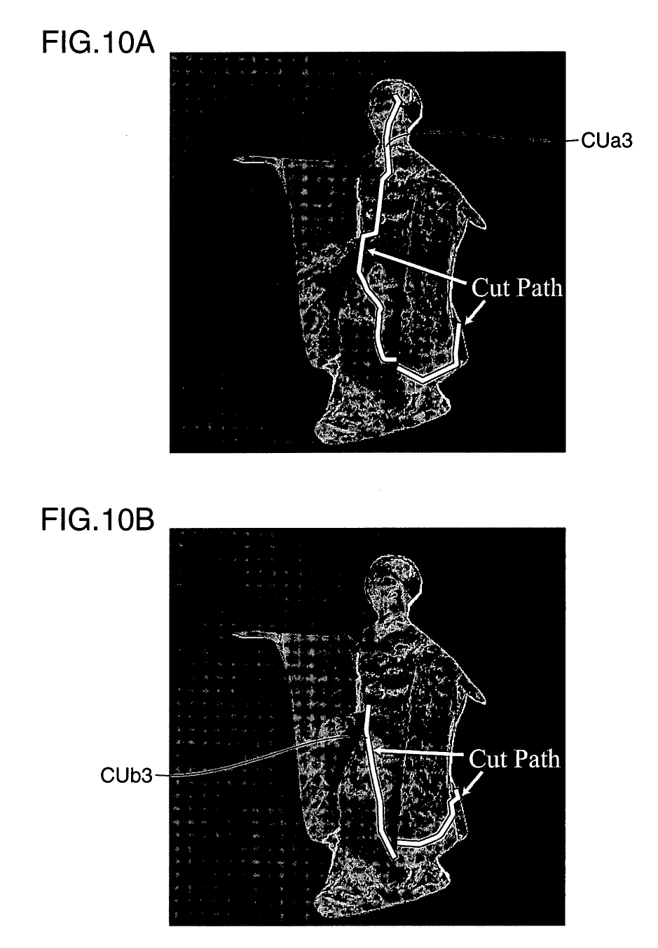

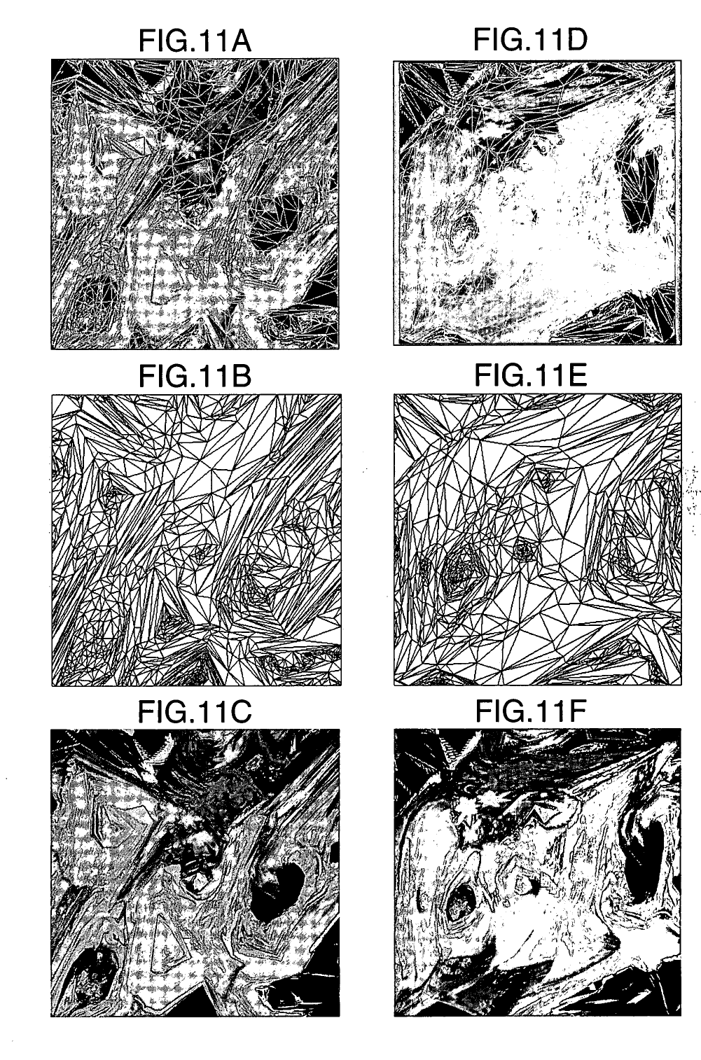

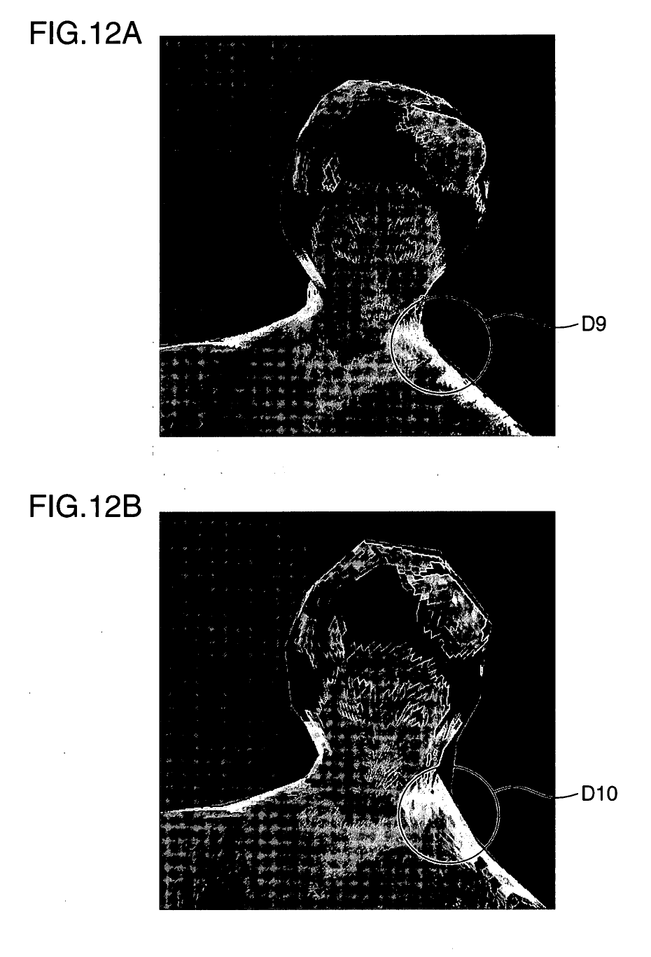

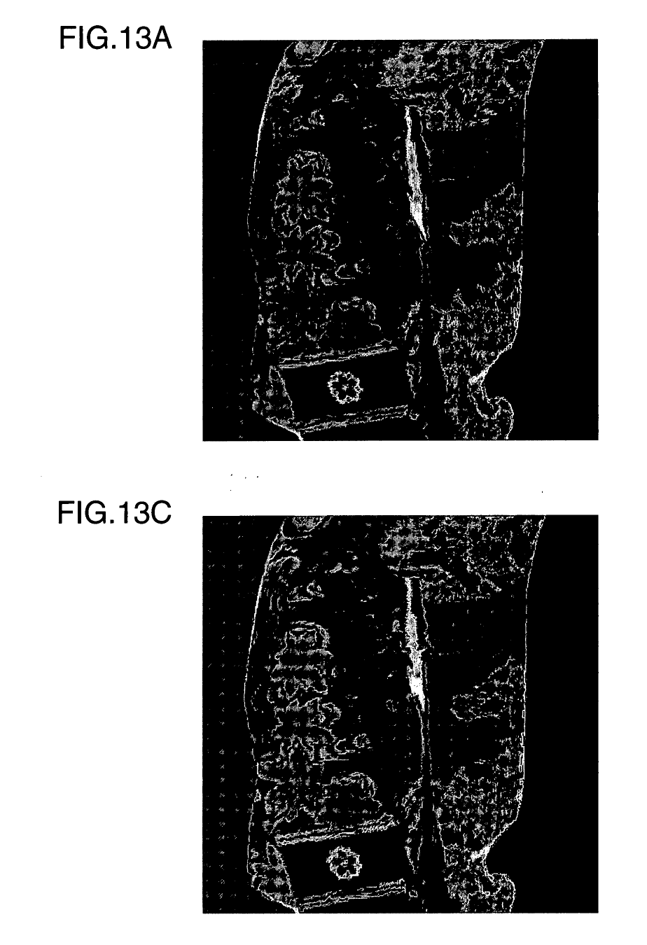

FIG. 10 are diagrams showing cut paths in the 3D images of the maiko, wherein FIG. 10A shows the case of applying the present invention and FIG. 10B shows the case of applying a background art. FIG. 11 are diagrams showing images of 2D planar figures of the maiko, wherein FIG. 11A shows the image of the 2D planar figure in the case of applying the present invention, FIG. 11B shows a mesh in the 2D planar figure image in the case of applying the present invention, FIG. 11C shows texture in the 2D planar figure image in the case of applying the present invention, FIG. 11D shows the image of the 2D planar figure in the case of applying the background art, FIG. 11E shows a mesh in the 2D planar figure image in the case of applying the background art, and FIG. 11F shows texture in the 2D planar figure image in the case of applying the background art. FIG. 12 are partial enlarged diagrams of head parts of the 3D images obtained by decompressing compressed data of the maiko, wherein FIG. 12A shows the case of applying the present invention and FIG. 12B shows the case of applying the background art. FIG. 13 are partial enlarged diagrams of sash parts of the 3D images obtained by decompressing the compressed data of the maiko, wherein FIG. 13A shows the case of applying the present invention and FIG. 13B shows the case of applying the background art.

The target objects are the Stanford bunny and the maiko actually picked up. The Stanford bunny has checkered patterns formed on the surface thereof from a head part to the tips of paw parts through a chest part and on the surface of a bottom part including the tail part. The Stanford bunny belongs to “the Stanford 3D Scanning Repository”.

If this Stanford bunny is polygonally approximated by triangular polygons, the 3D image shown in FIG. 6A is obtained, through which a polygon mesh data with 1502 polygons and 772 vertices and a texture data are obtained.

Here, if the present invention is applied, a cut path CUa2 is formed to extend from the tips of both ears, join at a neck part and reach the tail through a shoulder part, a lateral part, paw tips and a belly part (not shown) as shown by heavy line in FIG. 7A. On the other hand, if the background art is applied, a cut path CUb2 is formed to extend from the tip of one ear to the paw tips through the neck part, the shoulder part and the lateral part as shown by heavy line in FIG. 7B. Further, as can be understood from the comparison of parts D2 and D4 encircled in FIG. 7 and including from the lateral part to the paw tips, the cut path CUa2 in the case of applying the present invention is formed to pass through the parts having less texture as compared to the cut path CUb2 in the case of applying the background art. Further, the cut path CUa2 is formed not only at one ear, but also at the other ear as shown by a part D3 encircled in FIG. 7A.

As a result, the image of the 2D planar figure is such an image as shown in FIGS. 8A, 8B and 8C in the case of applying the present invention while being such an image as shown in FIGS. 8D, 8E and 8F in the case of applying the background art. As can be understood by the comparison of FIGS. 8A and 8D, better by the comparison of FIGS. 8C and 8F, parts having higher texture densities are more largely mapped in the case of applying the present invention than in the case of applying the background art. Thus, the 3D image obtained by decompressing the compressed data of the 2D planar figure image has less distortion in the checkered patterns in the case of applying the present invention than in the case of applying the background art. Particularly in the tail part, as can be understood by the comparison of FIGS. 9A and 9B, e.g. by the comparison of parts D5, D6 encircled in FIG. 9A and parts D7, D8 encircled in FIG. 9B, steps can be recognized in places that should be straight lines in the case of applying the background art, but such steps can be suppressed to have a better image quality if the present invention is applied. This is because the cut path CUa2 is formed also at the tail part and indicates that the cut path CUa2 in the case of applying the present invention effectively served to improve the image quality.

The maiko as another target object is wearing kimono having such a pattern that maple leaves are floating on the stream. If this maiko is polygonally approximated by triangular polygons, the 3D image shown in FIG. 6B is obtained, through which a polygon mesh data with 2000 polygons and 998 vertices and a texture data are obtained.

Here, if the present invention is applied, a cut path CUa3 is formed to extend from a face part to a position below the knees of leg parts through a neck part, a chest part, a belly part and a waist part, and extend laterally in substantially horizontal direction from the position below the knees to come back laterally in substantially horizontal direction on the surface of a sleeve through the rear side (not shown) of the sleeve as shown by heavy line in FIG. 10A. On the other hand, if the background art is applied, a cut path CUb3 is formed to extend from the bellow part to a position below the knees of leg parts through the waist part, and extend laterally in substantially horizontal direction from the position below the knees to come back laterally in substantially horizontal direction on the surface of the sleeve through the rear side (not shown) of the sleeve as shown by heavy line in FIG. 10B. As can be understood by the comparison of FIGS. 10A and 10B, the cut path CUa3 in the case of applying the present invention is also formed at an area from the face part to the neck part and an area from the chest part to the belly part unlike the cut path CUb3 in the case of applying the background art. Particularly, the cut path CUa3 is formed to extend from the forehead to the chin through the eye, nose and mouth in the uneven face surface.

As a result, the image of the 2D planar figure is such an image as shown in FIGS. 11A, 11B and 11C in the case of applying the present invention while being such an image as shown in FIGS. 11D, 11E and 11F in the case of applying the background art. Thus, the 3D image obtained by decompressing the compressed data of the 2D planar figure image has less distortion in the checkered patterns in the case of applying the present invention than in the case of applying the background art. Particularly in the head part, as can be understood by the comparison of FIGS. 12A and 12B, e.g. by the comparison of a part D9 encircled in FIG. 12A and a part D10 encircled in FIG. 12B, there is a large distortion on the left side of the neck and the entire face is extended in vertical direction in the case of applying the background art, whereas such a distortion is suppressed to improve the image quality in the case of applying the present invention. This is because the cut path CUa3 is also formed at the head part and indicates that the cut path CUa3 in the case of applying the present invention effectively served to improve the image quality.

The images of the sash part shown in FIG. 13 have a larger amount of texture information and are poor in unevenness by having a large radius of curvature. The influence of the selection of the cut path CU is small in such a part. This part has substantially the same image quality in the case of applying the present invention and in the case of applying the background art as can be understood by the comparison of FIGS. 13A and 13B, although the presence of the part where the cut path CUa3 is formed to improve the image quality such as the head part might possibly burden the data amount to lose information in the case of a limited data amount if the present invention is applied.

As can be shown in these examples, 3D images obtained by decompressing compressed data through the application of the present invention have less distortion as compared to the background art.

Although the 3D image data of the still images are described in the above first and second embodiments, the present invention is similarly applicable to 3D image data of moving images by being applied to 3D images of frames constituting the moving images since the moving images are a set of still images provided with time information.

In order to make efficiently compressed data capable of providing polygon meshes with little distortion after the decompression portable and transferable, compressed polygon mesh data and texture data generated as in the above first and second embodiments may be stored, for example, in recording mediums such as a flexible disk, a CD-ROM, a CD-R, a DVD and a DVD-R.

Various inventions are disclosed in this specification as described above. Main ones of these are summarized as follows.

(First Mode)

A 3D image data compression system comprises an unfolding/projecting section for generating a cut path by making cuts in a 3D image generated from a 3D image data, cutting the surface of an object open and unfolding it onto a 2D planar figure such that the cut path becomes the outer periphery of the 2D planar figure, and correlating geometric information and optical information of the 3D image data to points within the 2D planar figure; and a figure compressing section for compressing the 2D planar figure to generate a compressed 3D image data, wherein the unfolding/projecting section generates the cut path based on texture information of the surface of the 3D image so as to reduce the distortion of the 3D image reproduced from the compressed data, and correlates the geometric information and the optical information of the 3D image data with the points within the 2D planar figure based on a texture distribution of the surface of the 3D image so as to reduce the distortion of the 3D image reproduced from the compressed data.

According to the 3D image data compression system according to this first mode, the cut path is generated based on the texture distribution of the surface of the 3D image so as to reduce the distortion of the 3D image reproduced from the compressed data and the geometric information and the optical information of the 3D image data are correlated with the points within the 2D planar figure based on the texture distribution of the surface of the 3D image so as to reduce the distortion of the 3D image reproduced from the compressed data. Thus, a data amount can be efficiently compressed and decompressed 3D images with little distortion can be obtained.

(Second Mode)

In the 3D image data compression system of the first mode, the 3D image data includes a polygon mesh data and a texture data correlated with polygons of a polygon mesh generated from the polygon mesh data, and the unfolding/projecting section generates the cut path using the following function for expressing the texture distribution of the surface of the 3D image if s denotes the polygon, Aₛ an area of the polygon, p a pixel on the polygon, and dx(p), dy(p) spatial differentials of the texture at the pixel p:

$$T ( s ) = \frac{1}{{A}_{S}} {\int }_{S}^{} \sqrt{ⅆ {x ( p )}^{2} + ⅆ {y ( p )}^{2} ⅆ p} \qquad ( 1 )$$

and correlates the geometric information and the optical information of the 3D image data with the points within the 2D planar figure using the following function for expressing the texture distribution of the surface of the 3D image if m_{T}(s) denotes a geometric stretch metric, m_{G}(s) a weighting function, and ε a parameter:

$$m = {\sum }_{s} ( ( ɛ \times {m}_{T} ( s ) + 1 ) \times {m}_{G} ( s ) ) . \qquad ( 8 )$$

According to the 3D image data compression system of this second mode, the cut path is generated using equation (1) and the geometric information and the optical information of the 3D image data are correlated with the points within the 2D planar figure using equation (8). Therefore, information can be quantitatively processed, the data amount can be efficiently compressed and decompressed 3D images with little distortion can be obtained.

(Third Mode)

In the 3D image data compression system of the first mode, the unfolding/projecting section generates the cut path based on the texture distribution of the surface of the 3D image so as to reduce the distortion of the 3D image reproduced from the compressed data, and correlates the geometric information and the optical information of the 3D image data with the points within the 2D planar figure based on the texture distribution of the surface of the 3D image and continuity in a stretch direction in the case of unfolding the 3D image onto the 2D planar figure so as to reduce the distortion of the 3D image reproduced from the compressed data.

According to the 3D image data compression system of this third mode, the cut path is generated based on the texture distribution of the surface of the 3D image so as to reduce the distortion of the 3D image reproduced from the compressed data, and the geometric information and the optical information of the 3D image data are correlated with the points within the 2D planar figure based on the texture distribution of the surface of the 3D image and the continuity in the stretch direction in the case of unfolding the 3D image onto the 2D planar figure so as to reduce the distortion of the 3D image reproduced from the compressed data. Therefore, the data amount can be efficiently compressed and decompressed 3D images with little distortion can be obtained.

(Fourth Mode)

In the 3D image data compression system of the third mode, the 3D image data includes a polygon mesh data and a texture data correlated with polygons of a polygon mesh generated from the polygon mesh data, and the unfolding/projecting section generates the cut path using the following function for expressing the texture distribution of the surface of the 3D image if s denotes the polygon, Aₛ an area of the polygon, p a pixel on the polygon, and dx(p), dy(p) spatial differentials of the texture at the pixel p:

$$T ( s ) = \frac{1}{{A}_{S}} {\int }_{S}^{} \sqrt{ⅆ {x ( p )}^{2} + ⅆ {y ( p )}^{2} ⅆ p} \qquad ( 1 )$$

and correlates the geometric information and the optical information of the 3D image data with the points within the 2D planar figure using the following function for expressing the texture distribution of the surface of the 3D image and the continuity in the stretch direction in the case of unfolding the 3D image onto the 2D planar figure if m_{T}(s) denotes a geometric stretch metric, m_{G}(s) a weighting function, mₛ(e) an continuity evaluation metric and α₁, α₂ parameters:

$$m = {α}_{1} {\sum }_{s} {m}_{T} ( s ) \times {m}_{G} ( s ) + {α}_{2} {\sum }_{s} {m}_{s} ( e ) . \qquad ( 7 )$$

According to the 3D image data compression system of this fourth mode, the cut path is generated using equation (1) and the geometric information and the optical information of the 3D image data are correlated with the points in the 2D planar figure using equation (7). Therefore, information can be quantitatively processed, the data amount can be efficiently compressed and decompressed 3D images with little distortion can be obtained.

### Fifth Embodiment

In the 3D image data compression system according to any one of the first to fourth modes, the 3D image data is the data of frames constituting moving images.

According to the 3D image data compression system of this fifth mode, the data amount of 3D moving images can be efficiently compressed and compressed 3D moving images with little distortion can be obtained.

(Sixth Mode)

A 3D image data compression method comprises a cut path generating step of generating a cut path by making cuts in a 3D image generated from a 3D image data; an unfolding step of cutting the surface of an object open and unfolding it onto a 2D planar figure such that the cut path becomes the outer periphery of the 2D planar figure; a correlating step of correlating geometric information and optical information of the 3D image data with points within the 2D planar figure; and a figure compressing step of compressing the 2D planar figure to generate a compressed 3D image data, wherein the cut path is generated based on texture information of the surface of the 3D image so as to reduce the distortion of the 3D image reproduced from the compressed data in the cut path generating step, and the geometric information and the optical information of the 3D image data are correlated with the points within the 2D planar figure based on a texture distribution of the surface of the 3D image so as to reduce the distortion of the 3D image reproduced from the compressed data in the correlating step.

(Seventh Mode)

A 3D image data compression program causes a computer to perform a cut path generating step of generating a cut path by making cuts in a 3D image generated from a 3D image data; an unfolding step of cutting the surface of an object open and unfolding it onto a 2D planar figure such that the cut path becomes the outer periphery of the 2D planar figure; a correlating step of correlating geometric information and optical information of the 3D image data with points within the 2D planar figure; and a figure compressing step of compressing the 2D planar figure to generate a compressed 3D image data, wherein the cut path is generated based on texture information of the surface of the 3D image so as to reduce the distortion of the 3D image reproduced from the compressed data in the cut path generating step, and the geometric information and the optical information of the 3D image data are correlated with the points in the 2D planar figure based on a texture distribution of the surface of the 3D image so as to reduce the distortion of the 3D image reproduced from the compressed data in the correlating step.

(Eight Mode)

A computer-readable recording medium stores a 3D image data compression program for causing a computer to perform a cut path generating step of generating a cut path by making cuts in a 3D image generated from a 3D image data; an unfolding step of cutting the surface of an object open and unfolding it onto a 2D planar figure such that the cut path becomes the outer periphery of the 2D planar figure; a correlating step of correlating geometric information and optical information of the 3D image data with points in the 2D planar figure; and a figure compressing step of compressing the 2D planar figure to generate a compressed 3D image data, wherein the cut path is generated based on texture information of the surface of the 3D image so as to reduce the distortion of the 3D image reproduced from the compressed data in the generating step, and the geometric information and the optical information of the 3D image data are correlated with the points in the 2D planar figure based on a texture distribution of the surface of the 3D image so as to reduce the distortion of the 3D image reproduced from the compressed data in the correlating step.

According to the 3D image data compression method of the sixth mode, the 3D image data compression program of the seventh mode and the computer-readable recording medium of the eight mode storing the 3D image data compression program, the cut path is generated based on the texture distribution of the surface of the 3D image so as to reduce the distortion of the 3D image reproduced from the compressed data and the geometric information and the optical information of the 3D image data are correlated with the points in the 2D planar figure based on the texture distribution of the surface of the 3D image so as to reduce the distortion of the 3D image reproduced from the compressed data. Thus, the data amount can be efficiently compressed and compressed 3D images with little distortion can be obtained.

(Ninth Mode)

In the 3D image data compression method of the sixth mode, in the correlating step, the geometric information and the optical information of the 3D image data are correlated with the points within the 2D planar figure based on the texture distribution of the surface of the 3D image and continuity in a stretch direction in the case of unfolding the 3D image onto the 2D planar figure so as to reduce the distortion of the 3D image reproduced from the compressed data.

(Tenth Mode)

In the 3D image data compression program of the seventh mode, in the correlating step, the geometric information and the optical information of the 3D image data are correlated with the points within the 2D planar figure based on the texture distribution of the surface of the 3D image and continuity in a stretch direction in the case of unfolding the 3D image onto the 2D planar figure so as to reduce the distortion of the 3D image reproduced from the compressed data.

(Eleventh Mode)

In the recording medium of the eighth mode, in the correlating step, the geometric information and the optical information of the 3D image data are correlated with the points within the 2D planar figure based on the texture distribution of the surface of the 3D image and continuity in a stretch direction in the case of unfolding the 3D image onto the 2D planar figure so as to reduce the distortion of the 3D image reproduced from the compressed data.

According to the 3D image data compression method of the ninth mode, the 3D image data compression program of the tenth mode and the computer-readable recording medium of the eleventh mode storing the 3D image data compression program, the cut path is generated based on the texture distribution of the surface of the 3D image so as to reduce the distortion of the 3D image reproduced from the compressed data, and the geometric information and the optical information of the 3D image data are correlated with the points in the 2D planar figure based on the texture distribution of the surface of the 3D image and the continuity in the stretch direction in the case of unfolding the 3D image onto the 2D planar figure so as to reduce the distortion of the 3D image reproduced from the compressed data. Therefore, the data amount can be efficiently compressed and compressed 3D images with little distortion can be obtained.

(Twelfth Mode)

A computer-readable recording medium stores a compressed 3D image data for generating a 3D image, wherein the compressed data is generated by the 3D image data compression method according to the sixth or seventh mode.

According to the recording medium of the twelfth mode, since the data capable of providing a compressed 3D image with little distortion can be efficiently compressed, a greater amount of 3D images can be stored in the recording medium of the same capacity and an efficiently compressed data capable of providing a decompressed 3D image with little distortion can be made portable or transferable.

### INDUSTRIAL APPLICABILITY

According to the present invention, there can be provided a 3D image data compression system, a 3D image data compression method, a 3D image data compression program using the 3D image data compression method and a computer-readable recording medium storing the 3D image data compression program which can efficiently compress a data amount and obtain a compressed 3D image with little distortion. Further, a recording medium can be provided which stores a compressed 3D image data obtained by such a 3D image data compression method.

1. A 3D image data compression system, comprising:
an unfolding/projecting section for generating a cut path by making cuts in a 3D image generated from a 3D image data, cutting the surface of an object open and unfolding it onto a 2D planar figure such that the cut path becomes the outer periphery of the 2D planar figure, and correlating geometric information and optical information of the 3D image data with points within the 2D planar figure; and
a figure compressing section for compressing the 2D planar figure to generate a compressed 3D image data,
wherein the unfolding/projecting section generates the cut path based on texture information of the surface of the 3D image so as to reduce the distortion of the 3D image reproduced from the compressed data, and correlates the geometric information and the optical information of the 3D image data with the points within the 2D planar figure based on a texture distribution of the surface of the 3D image so as to reduce the distortion of the 3D image reproduced from the compressed data.

2. A 3D image data compression system according to claim 1, wherein:
the 3D image data includes a polygon mesh data and a texture data correlated with polygons of a polygon mesh generated from the polygon mesh data; and
the unfolding/projecting section generates the cut path using the following function for expressing the texture distribution of the surface of the 3D image if s denotes the polygon, Aₛ an area of the polygon, p a pixel on the polygon, and dx(p), dy(p) spatial differentials of the texture at the pixel p:
$$T ( s ) = \frac{1}{{A}_{S}} {\int }_{S} \sqrt{ⅆ {x ( p )}^{2} + ⅆ {y ( p )}^{2} ⅆ p} ,$$
and correlates the geometric information and the optical information of the 3D image data with the points within the 2D planar figure using the following function for expressing the texture distribution of the surface of the 3D image if m_{T}(s) denotes a geometric stretch metric, m_{G}(s) a weighting function, and a parameter:
$$m = {\sum }_{s} ( ( ɛ \times {m}_{T} ( s ) + 1 ) \times {m}_{G} ( s ) ) .$$

3. A 3D image data compression system according to claim 1, wherein the unfolding/projecting section generates the cut path based on the texture distribution of the surface of the 3D image so as to reduce the distortion of the 3D image reproduced from the compressed data, and correlates the geometric information and the optical information of the 3D image data with the points within the 2D planar figure based on the texture distribution of the surface of the 3D image and continuity in a stretch direction in the case of unfolding the 3D image onto the 2D planar figure so as to reduce the distortion of the 3D image reproduced from the compressed data.

4. A 3D image data compression system according to claim 3, wherein:
the 3D image data includes a polygon mesh data and a texture data correlated with polygons of a polygon mesh generated from the polygon mesh data; and
the unfolding/projecting section generates the cut path using the following function for expressing the texture distribution of the surface of the 3D image if s denotes the polygon, Aₛ an area of the polygon, p a pixel on the polygon, and dx(p), dy(p) spatial differentials of the texture at the pixel p:
$$T ( s ) = \frac{1}{{A}_{S}} {\int }_{S} \sqrt{ⅆ {x ( p )}^{2} + ⅆ {y ( p )}^{2} ⅆ p} ,$$
and correlates the geometric information and the optical information of the 3D image data with the points within the 2D planar figure using the following function for expressing the texture distribution of the surface of the 3D image and the continuity in the stretch direction in the case of unfolding the 3D image onto the 2D planar figure if m_{T}(s) denotes a geometric stretch metric, m_{G}(s) a weighting function, mₛ(e) an continuity evaluation metric and α₁, α₂ parameters:
$$m = {α}_{1} {\sum }_{s} {m}_{T} ( s ) \times {m}_{G} ( s ) + {α}_{2} {\sum }_{s} {m}_{s} ( e ) .$$

5. A 3D image data compression system according to claim 1, wherein the 3D image data is the data of frames constituting moving images.

6. A 3D image data compression method, comprising:
a cut path generating step of generating a cut path by making cuts in a 3D image generated from a 3D image data;
an unfolding step of cutting the surface of an object open and unfolding it onto a 2D planar figure such that the cut path becomes the outer periphery of the 2D planar figure;
a correlating step of correlating geometric information and optical information of the 3D image data with points within the 2D planar figure; and
a figure compressing step of compressing the 2D planar figure to generate a compressed 3D image data,
wherein:
the cut path is generated based on texture information of the surface of the 3D image so as to reduce the distortion of the 3D image reproduced from the compressed data in the cut path generating step, and
the geometric information and the optical information of the 3D image data are correlated with the points within the 2D planar figure based on a texture distribution of the surface of the 3D image so as to reduce the distortion of the 3D image reproduced from the compressed data in the correlating step.

7. A 3D image data compression method according to claim 6, wherein, in the correlating step, the geometric information and the optical information of the 3D image data are correlated with the points within the 2D planar figure based on the texture distribution of the surface of the 3D image and continuity in a stretch direction in the case of unfolding the 3D image onto the 2D planar figure so as to reduce the distortion of the 3D image reproduced from the compressed data.

8. A 3D image data compression program for causing a computer to perform:
a cut path generating step of generating a cut path by making cuts in a 3D image generated from a 3D image data;
an unfolding step of cutting the surface of an object open and unfolding it onto a 2D planar figure such that the cut path becomes the outer periphery of the 2D planar figure;
a correlating step of correlating geometric information and optical information of the 3D image data with points within the 2D planar figure; and
a figure compressing step of compressing the 2D planar figure to generate a compressed 3D image data,
wherein:
the cut path is generated based on texture information of the surface of the 3D image so as to reduce the distortion of the 3D image reproduced from the compressed data in the generating step, and
the geometric information and the optical information of the 3D image data are correlated with the points within the 2D planar figure based on a texture distribution of the surface of the 3D image so as to reduce the distortion of the 3D image reproduced from the compressed data in the correlating step.

9. A 3D image data compression program according to claim 8, wherein, in the correlating step, the geometric information and the optical information of the 3D image data are correlated with the points within the 2D planar figure based on the texture distribution of the surface of the 3D image and continuity in a stretch direction in the case of unfolding the 3D image onto the 2D planar figure so as to reduce the distortion of the 3D image reproduced from the compressed data.

10. A computer-readable recording medium storing a 3D image data compression program for causing a computer to perform:
a cut path generating step of generating a cut path by making cuts in a 3D image generated from a 3D image data;
an unfolding step of cutting the surface of an object open and unfolding it onto a 2D planar figure such that the cut path becomes the outer periphery of the 2D planar figure;
a correlating step of correlating geometric information and optical information of the 3D image data with points within the 2D planar figure; and
a figure compressing step of compressing the 2D planar figure to generate a compressed 3D image data,
wherein:
the cut path is generated based on texture information of the surface of the 3D image so as to reduce the distortion of the 3D image reproduced from the compressed data in the generating step, and the geometric information and the optical information of the 3D image data are correlated with the points within the 2D planar figure based on a texture distribution of the surface of the 3D image so as to reduce the distortion of the 3D image reproduced from the compressed data in the correlating step.

11. A recording medium according to claim 10, wherein, in the correlating step, the geometric information and the optical information of the 3D image data are correlated with the points within the 2D planar figure based on the texture distribution of the surface of the 3D image and continuity in a stretch direction in the case of unfolding the 3D image onto the 2D planar figure so as to reduce the distortion of the 3D image reproduced from the compressed data.

12. A computer-readable recording medium storing a compressed 3D image data for generating a 3D image, wherein the image data is generated by the 3D image data compression method according to claim 7.

13. A 3D image data compression system according to claim 2, wherein the 3D image data is the data of frames constituting moving images.

14. A 3D image data compression system according to claim 3, wherein the 3D image data is the data of frames constituting moving images.

15. A 3D image data compression system according to claim 4, wherein the 3D image data is the data of frames constituting moving images.
